(19) United States
(12) Patent Application Publication
(10) Pub. No.: US 2020/0186454 A1
(43) Pub. Date: Jun. 11, 2020

(54) SYSTEM AND METHOD FOR DISTRIBUTED IMAGE PROCESSING

(71) Applicant: Spot AI, Inc., Los Altos, CA (US)

(72) Inventor: Tanuj Thapliyal, Los Altos, CA (US)

(21) Appl. No.: 16/708,127

(22) Filed: Dec. 9, 2019

Related U.S. Application Data
(60) Provisional application No. 62/777,192, filed on Dec. 9, 2018.

(51) Int. Cl. H04L 12/26; H04L 29/06

(52) U.S. Cl. CPC H04L 43/0876; H04L 65/80; H04L 65/601; H04L 65/608

(57) ABSTRACT

A system for distributed image processing includes a distributed compute cluster having a plurality of analytic compute endpoints each exposing a network interface. The analytic compute endpoints are configured to process video data provided by a plurality of video cameras, where each video camera has a sensor endpoint exposing a network interface. The system further includes a controller that is configured to identify one of the analytic compute endpoints having available processing resources, and facilitate a connection between one of the sensor endpoints and the analytic compute endpoint. The analytic compute endpoint is then able to receive and process the video data.

### CROSS-REFERENCE TO RELATED APPLICATION

This application claims priority to and the benefit of U.S. Provisional Patent Application No. 62/777,192, filed on Dec. 9, 2018, the entirety of which is incorporated by reference herein.

### FIELD OF THE INVENTION

The present disclosure relates generally to image processing, and, more specifically, to systems and methods for elastic and scalable distributed processing of image data from video camera systems.

### BACKGROUND

Video analytics system controllers have difficulty scaling to handle greater numbers of camera feeds, higher framerates, higher resolutions, and sophisticated image processing algorithms (such as motion threshold detectors, pixel or color normalization, contrast, brightness and saturation tuning, neural networks to identify image contents, such as face, age, gender, person, car, and other objects, and so on). To support this, these systems generally are expensive and require high performance hardware (either via one or more cloud instances or one or more on-premises servers). For example, existing systems often require a discrete networking switch (multiple Ethernet physical layers (PHY)/medium access controls (MAC)) connected to a high-powered central processing unit (CPU) which then processes the packets and conducts the image processing either on the CPU, a field-programmable gate array (FPGA), graphics processing unit (GPU) subsystem, or image processing application-specific integrated circuits (ASICs). Alternatively, existing approaches require a hosted solution in the cloud which pipes in video feeds over network packets (using streams implemented by, e.g., Real-Time Messaging Protocol (RTMP), Real-Time Streaming Protocol (RTSP), Web Real-Time Communication (WebRTC), Hypertext Transfer Protocol (HTTP) Live Streaming (HLS), MPEG Dynamic Adaptive Streaming over HTTP (MPEG-DASH)), image streams (e.g., motion-JPEG), images (e.g., PNG, BMP, etc.) and then runs image or video analytics using powerful underlying hardware (e.g., Intel Quad Core i7 CPU, 8 gigabytes random-access memory (RAM), NVIDIA 1080X GPU, etc.).

### BRIEF SUMMARY

In one aspect, a system for distributed image processing comprises a distributed compute cluster that comprises a plurality of analytic compute endpoints each exposing at least one network interface, wherein the analytic compute endpoints are configured to process video data provided by a plurality of video cameras, each video camera comprising a sensor endpoint exposing at least one network interface; and a controller configured to: identify a first one of the analytic compute endpoints having available processing resources; and facilitate a connection of a first one of the sensor endpoints to the first analytic compute endpoint over a network via the network interface of the first sensor endpoint and the network interface of the first analytic compute endpoint; wherein the first analytic compute endpoint, following the connection to the first sensor endpoint, receives and processes the first video data. Other aspects of the foregoing include corresponding methods and non-transitory computer-readable media storing instructions that, when executed by a processor, implement such methods.

Various implementations of the foregoing aspects can include one or more of the following features. The analytic compute endpoints are disposed on one or more appliances having hardware separate from the plurality of video cameras. The analytic compute endpoints are disposed on the plurality of video cameras. The first analytic compute endpoint comprises a container configured to execute video data processing software using at least one processor available to the first analytic compute endpoint. The at least one processor comprises a central processing unit and a tensor processing unit. The first video data is streamed from the first sensor endpoint to the first analytic compute endpoint and the first video data is stored as a plurality of video segments. The video segments are converted into pixel domain, and the first video data is processed by analyzing frames of the video segments based on one or more detection filters. Each video segment comprises video data between only two consecutive keyframes. Receiving and processing the first video data by the first analytic compute endpoint comprises: sending a request over the network to the first sensor endpoint for the first video data; and following the processing of the first video data, storing results of the processing in a data storage instance accessible to the sensor endpoints and the analytic compute endpoints. The distributed compute cluster is disposed behind a firewall or router on an infrastructure network, and the distributed compute cluster is made accessible from outside the firewall or router.

The details of one or more implementations of the subject matter described in the present specification are set forth in the accompanying drawings and the description below. Other features, aspects, and advantages of the subject matter will become apparent from the description, the drawings, and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the implementations. In the following description, various implementations are described with reference to the following drawings.

FIG. 1 depicts a high-level architecture of an implementation of a system for distributed image processing.

FIG. 2 depicts one implementation of a distributed compute cluster within the system of FIG. 1.

FIG. 3 depicts another implementation of a distributed compute cluster within the system of FIG. 1.

FIG. 4 depicts a method for processing a video stream according to an implementation.

FIG. 5 depicts a method of distributed image processing according to an implementation.

### DETAILED DESCRIPTION

Described herein is an elastic, lightweight, and scalable analytics system controller which can execute directly on one or more computing devices (e.g., appliances, embedded cameras, etc.) and need not require additional hardware or cloud instances to scale. The approach is lower cost than traditional approaches, can obviate the need for any discrete controller appliance in certain circumstances (either on-premises or in the cloud), and is also much more scalable and can handle higher camera counts, better frame rates, better resolution, more powerful algorithms, and so on, than currently available techniques.

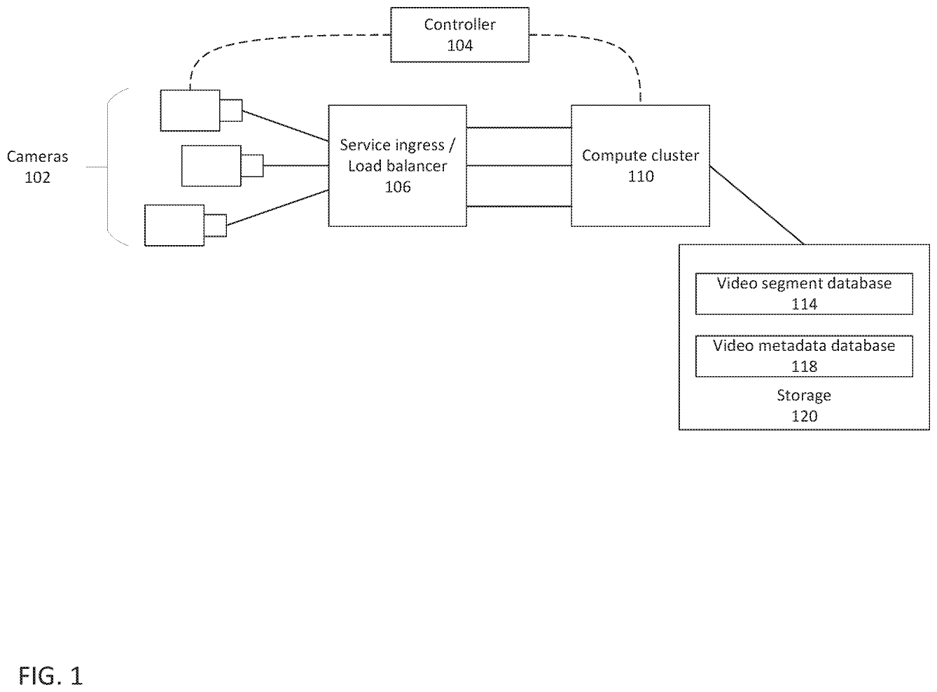

Referring to FIG. 1, in one implementation, a system for distributed image processing includes a compute cluster 110 containing computing resources (e.g., processing units such as CPUs, GPUs, tensor processing units (TPUs); computer-readable memories and storage media storing instructions to be executed by the processing units, etc.). Computing resources within the compute cluster 110 can be grouped into individual analytic compute endpoints. Cameras 102 (e.g., security cameras, consumer video cameras, thermal imaging cameras, etc.) are connected to each other using a software-defined network (such as with a Docker swarm or Kubernetes with a flannel or weave network overlay driver), and the analytic compute endpoints can execute containers (e.g., Docker, containerd, etc.), virtual machines, or applications running natively on an operating system. The analytic compute endpoints can have exposed networking interfaces (for example, in the case of Kubernetes, at a pod abstraction (a set of containers)) whose service hostnames are enumerated and discoverable via a Domain Name System (DNS) server.

In one implementation, the system includes a controller 104 that can be analogized to a telephone switchboard operator. The controller 104 identifies idle compute resources in the compute cluster 110 and then “patches” a sensor endpoint (e.g., an HTTP, Transmission Control Protocol (TCP), or User Datagram Protocol (UDP) on a camera 102 exposed by a container or set of containers where an image can be retrieved) to an analytic compute endpoint in the compute cluster 110 (e.g., HTTP, TCP, or UDP endpoint). Each camera can have a webserver that listens for HTTP requests for video image data at a set time, duration, and quality level, and provide an HTTP response with the video image data. Alternatively, the camera can write down the video image data into a distributed file storage system (e.g., Amazon S3 buckets, MinIO) and provide the location thereof (e.g., Uniform Resource Locator (URL)) in the HTTP response. The analytic compute endpoint can then directly retrieve the video image data to process it and return the result back to the controller 104 asynchronously. This prevents the controller 104 from being CPU-blocked by processing high bandwidth traffic and allows the system to scale to many cameras at once.

The analytic compute endpoint is preceded by a service ingress controller and load balancer 106, which takes in the HTTP request and routes it to an analytic compute endpoint (e.g., container or pod) which has available processing resources (e.g., is idle, or if not idle, has the shortest queue). The loading across analytic compute endpoints is balanced (i.e., only a few cameras 102 at a time are actively seeing things, so idle resources can conduct extra processing). The cloud can contain infinitely elastic reservoir containers for extra idle compute.

In some implementations, the system pre-processes images on the cameras 102 where the images are collected to determine if the images need to be sent to the analytic endpoints (e.g., only send if there is motion detected). This has the advantage of avoiding hardware resource blocks (for example, the networking switch, CPU, RAM, etc.) by the controller 104 itself. Rather, the system can leverage gigabit Ethernet or 802.11/a/b/g/n/ac/ax WiFi so that point-to-point connections are made between a signal to analyze (in this case an image) and the analytic compute endpoint. Each of the analytic endpoints can record its results into data storage instance 120 (e.g., a MySQL database instance) that is also discoverable inside the compute cluster 110 and runs as a service. The data storage instance 120 can have a persistent volume mount where database or other files can be saved. In other implementations, cameras 102 record video and image data directly into storage 120, and analytic compute endpoints can access the data directly from storage 120 using an identifier (e.g., file path, URL).

Load balancing for the controller 104 performed by the service ingress/load balancer components 106 can consider any suitable factors, such as target latency, desired accuracy or confidence score of the result, cost of utilizing cloud compute, supporting ensemble workloads (run multiple algorithms on the same image and take a weighted result), chopping the input frame into reduced dimension sections and running each of those sub-images concurrently, and desired framerate. Each applicable factor can be input into a weighing equation so that at runtime the optimal distribution of container resources at optimal locations are utilized to run analytics tasks. The controller 104 can employ logic to determine which sensor endpoints to patch to which analytic compute endpoints. As a simple example, a desired latency can be configured, and the controller 104 can enter a loop state and make HTTP GET requests to the ingress of the analytic service endpoints to determine which can perform tasks with such latency.

Video storage can be similarly load balanced across endpoints (e.g., analytic compute endpoints, sensor endpoints, or other available data storages). For example, a distributed object store (such as MinIO) can be configured across the endpoints and abstract a network-accessible filesystem into specific physical idle storage on each endpoint. In another implementation, a Kubernetes cluster spans multiple endpoints (e.g., cameras and appliances, where the appliances serve as a resource pool for extra compute or extra storage when the cameras have fully exhausted their available resources). Short video snippets are written to an object store (e.g., video segment database 114), where the store itself determines where to write the snippet. The video snippets can be a set duration (several seconds or minutes in length each) and their file paths and names can be hashed. Metadata associated with the video snippets, such as timestamps, motion events (e.g., detect motion in a zone near a door on the left side of the frame when motion sensitivity is high), and descriptive content of events in the video (e.g., detect faces and positions, compare against database of known faces, record face vector and identity), can be stored in a video metadata database 118. Event metadata can include timestamps of the events, duration, and boxed or contour zones in the frames where such events take place. When video needs to be retrieved, the snippets can be pulled and stitched together into a longer video on, for example, another container set in the cluster 110 or even client-side. This allows excess storage of endpoints to be utilized by footage from more active cameras. The writes can be triggered by events such as motion, detection of a person or vehicle, and so on, within a time window and/or a location window.

In one implementation, in order for this edge native video infrastructure to be easily and remotely accessible, an infrastructure endpoint that sits behind a firewall or router (which can include Network Address Translation (NAT) or other similar software or device) is exposed. Moreover, using container orchestration, unique dedicated tunnels can be exposed per camera feed. If exit nodes are terminated on an edge infrastructure (e.g., a content delivery network), then routing is intelligently performed only when an end user is trying to retrieve video, with the fastest path from that saved video to the user's client.

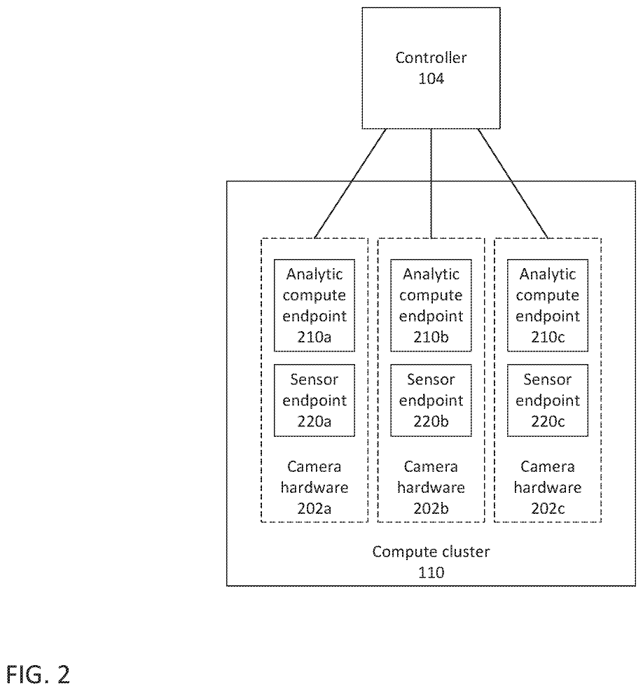

FIG. 2 depicts one implementation of the compute cluster 110, in which the sensor endpoints and analytic endpoints are disposed on the camera hardware. For instance, analytic compute endpoint 210a and sensor endpoint 220a operate on camera hardware 202a, analytic compute endpoint 210b and sensor endpoint 220b operate on camera hardware 202b, and analytic compute endpoint 210c and sensor endpoint 220c operate on camera hardware 202c. Although three cameras 202a, 202b, and 202c are depicted for convenience, one will appreciate that the compute cluster 110 can include any number of cameras. Thus, using the principles describes above, the controller 104 identifies which analytic compute endpoints (and thus which camera hardware used by the analytic compute endpoints) have available resources, and facilitates the connection of one sensor endpoint requiring video data processing to an analytic compute endpoint with available resources. As such, idle cameras (e.g., cameras not detecting any events) can be used to assist with the processing of video data captured by active cameras that are experiencing motion or other detected events.

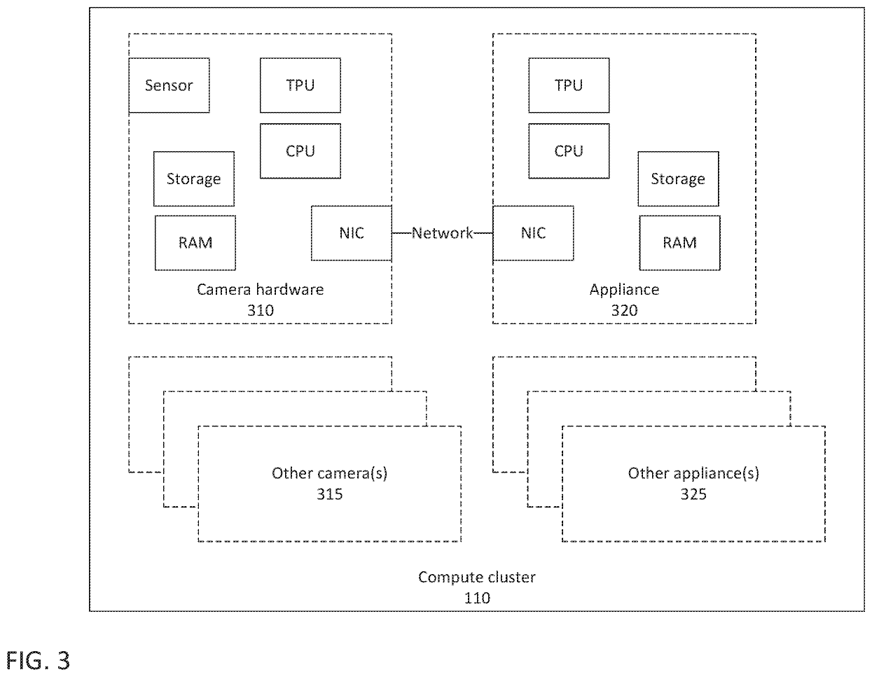

FIG. 3 depicts an alternative implementation in which the computer cluster 110 includes appliances 320 and 325 on which the analytic compute endpoints are disposed. In this implementation, the camera hardware 310 and 315 include sensor endpoints but do not include analytic compute endpoints. As such, the controller 104 can facilitate a connection between the network interface of a sensor endpoint on camera hardware 310 and the network interface of an analytic compute endpoint on appliance 320. The analytic compute endpoint on appliance 320 can then process video data from the camera hardware 310 and store it using the techniques described above. While FIG. 3 depicts multiple appliances 320 and 325, in some implementations, there is only one appliance 320. Further, a particular appliance may include one or more analytic compute endpoints, and each can have an exposed network interface.

In further implementations, compute cluster 110 includes analytic compute endpoints disposed on a combination of different types of computing devices. For example, analytic compute endpoints can exist on one or more cameras and one or more appliances. Servers or other general-purpose computing systems can also function to provide analytic compute endpoints that operate as described herein. Each analytic compute endpoint can utilize the resources of its underlying system (which may be allocated to the endpoint in part by a container or virtual machine), which may include CPUs, GPUs, TPUs, non-transitory computer-readable storage media, network interface cards (NICs), and so on. A Kubernetes cluster or similar container orchestration can be deployed across the underlying systems, which can scan and discover cameras on the network.

In some implementations in which the analytic compute endpoints are disposed on the cameras, the controller configures cameras, sets tokens and secrets, manages camera health, manages the analytics engine, and patches particular cameras to particular analytic types. A stateless analytics engine contains multiple webservers behind an ingress/load balancer. Each webserver endpoint uniquely sits on top of a computing hardware resource, such as a CPU or TPU. Each camera has a webserver that accepts requests for an image or video snippet at a set timestamp, duration, and image quality/resolution. The analytics engine, controller, and cameras are all connected over a software-defined network with encryption and hostname/services resolution. An end user can specify an analytic type for a particular camera to the controller (e.g., license plate detection on camera serial number aaaa-2222). The controller sets the analytic engine to retrieve video or images from the target camera directly at a set interval. The analytic engine can then route the request to an analytic compute endpoint that has the shortest work queue length. An analytic compute endpoint can also be chosen based on hardware type (e.g., TPU) or desired latency (e.g., 100 ms runtime). The analytic compute endpoint directly retrieves relevant video content from the camera itself and then writes its analytic result into a distributed database (e.g., PostgreSQL). In implementations where the analytic compute endpoints are disposed on appliances, the topology can otherwise be the same as above. Rather than webserver endpoints running on the cameras, the analytic compute endpoints can retrieve the video feed directly from a camera and expose a webserver to allow other components of the system to ingest the video image data and/or processing results.

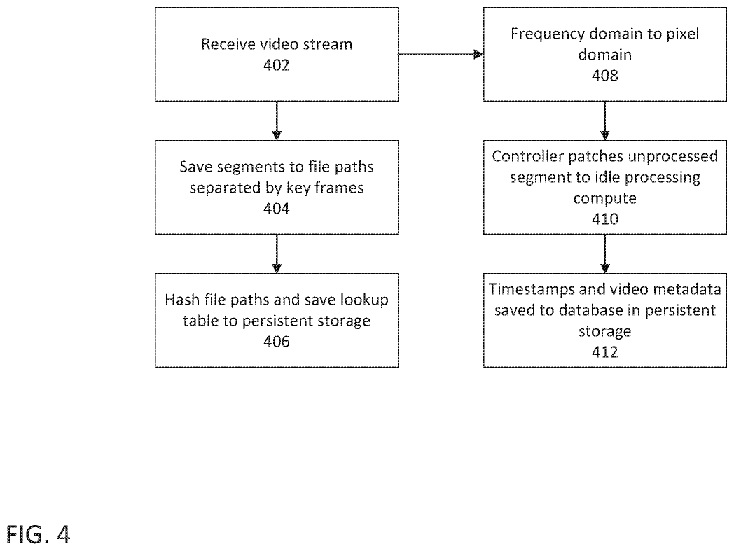

FIG. 4 depicts one implementation of a process for video stream processing using the systems described herein. In Step 402, a video stream (e.g., High Efficiency Video Coding (HEVC)/H.265 or H.264 MPEG-4) is received into the distributed computer cluster (e.g., an appliance cluster). The video stream is saved into segments, for example, files that consist of a start keyframe and a stop keyframe and video data between the keyframes (Step 404). The keyframes can be, but need not be, consecutive keyframes. The video storage can be situated on one or more endpoints, e.g., appliances, or be a connected network file server (NFS), overlay filesystem, or combination of the foregoing. A distributed object store, such as MinIO, can also be used to implement video segment storage. Each camera can encode video at a pre-specified framerate and inter-frame distance. For example, a 25 frame-per-second recording with 50 frames between keyframes would result in 2 second segments of video being saved. The video segments are stored on a host system or other storage as described above and are hashed so a lookup table can be used to instantly retrieve and stitch together relevant snippets (Step 406).

In Step 408, in parallel, the video segments are converted into the pixel domain using hardware acceleration (e.g., GPUs, H.264 or H.265 decode blocks, JPEG encode blocks, etc.). Then, the frames are analyzed for their content based on pre-set filters that can be programmed on a per-camera basis. Examples of such filters include motion detection, zone or region-based motion detection, face detection, and vehicle detection. For a construction customer, an example detector could be a hazard cone detector that is deployed on the outward road facing cameras for inbound trucks and vehicle traffic. These algorithms can run wherever idle compute is available in the computer cluster, using the load balancer and switchboard operator topology described above (Step 410).

In Step 412, a metadata stream is stored in separate storage, such as a metadata database, from the video segment file paths. The metadata can include timestamp information, detected event information, and other forms of metadata. Queries can be executed on the metadata database to obtain timestamps (e.g., timestamps matching a queried event). Then, a corresponding query can be executed with respect to a video segments database to obtain a list of segments matching the timestamps.

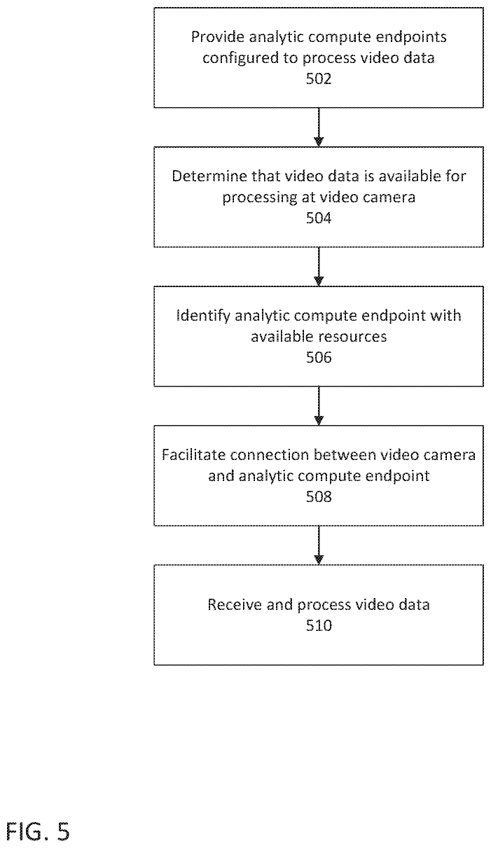

Referring now to FIG. 5, a method for distributed image processing includes the following steps. In Step 502, a plurality of analytic compute endpoints is provided, with each exposing at least one network interface. The analytic compute endpoints are configured to process video data provided by a plurality of video cameras, each having a sensor endpoint exposing at least one network interface. In Step 504, a controller determines that one of the sensor endpoints has video data available for processing. In Step 506, the controller identifies an analytic compute endpoint having available processing resources. In Step 508, the controller facilitates a connection between the sensor endpoint and the analytic compute endpoint over a network via the network interfaces of the two endpoints. In Step 510, following the connection to the sensor endpoint, the analytic compute endpoint receives and processes the video data.

The techniques described herein can operate in a business or home as a network of deployable cameras connected through a networking interface like Ethernet (10/100/gigabit) or Wi-Fi (802.11a/b/g/n/ac/ax) and, optionally, include one or more appliances or other analytic compute endpoints configured to provide the functionality described herein. Operators of these businesses and/or information technology managers can set up the equipment and use the software on a regular basis through a web-connected client (mobile phone, laptop, tablet, desktop, etc.).

The system can leverage emerging network and computing abstraction and virtualization technology (Docker, Kubernetes) built for a resource-rich Intel x86 CPU architecture with gigabytes of RAM and port it to run on a resource efficient embedded ARM processor with one or fewer gigabytes of RAM. The system can also leverage power-efficient artificial intelligence (AI) silicon (e.g., Intel Movidius, Gyrfalcon, Google Coral, Nvidia Jetson line), Linux, and microservices that are prevalent in datacenters in a new context at the edge of a network on cameras themselves or on other server appliance endpoints.

A system of one or more computing devices, including cameras and application-specific appliances, can be configured to perform particular operations or actions described herein by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

Alternatively, or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of” “only one of” or “exactly one of” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

1. A system for distributed image processing, the system comprising a distributed compute cluster comprising:
a plurality of analytic compute endpoints each exposing at least one network interface, wherein the analytic compute endpoints are configured to process video data provided by a plurality of video cameras, each video camera comprising a sensor endpoint exposing at least one network interface; and
a controller configured to:
identify a first one of the analytic compute endpoints having available processing resources; and
facilitate a connection of a first one of the sensor endpoints to the first analytic compute endpoint over a network via the network interface of the first sensor endpoint and the network interface of the first analytic compute endpoint;
wherein the first analytic compute endpoint, following the connection to the first sensor endpoint, receives and processes the first video data.

2. The system of claim 1, wherein the analytic compute endpoints are disposed on one or more appliances having hardware separate from the plurality of video cameras.

3. The system of claim 1, wherein the analytic compute endpoints are disposed on the plurality of video cameras.

4. The system of claim 1, wherein the first analytic compute endpoint comprises a container configured to execute video data processing software using at least one processor available to the first analytic compute endpoint.

5. The system of claim 4, wherein the at least one processor comprises a central processing unit and a tensor processing unit.

6. The system of claim 1, wherein the first video data is streamed from the first sensor endpoint to the first analytic compute endpoint and wherein the first video data is stored as a plurality of video segments.

7. The system of claim 6, wherein the video segments are converted into pixel domain, and wherein the first video data is processed by analyzing frames of the video segments based on one or more detection filters.

8. The system of claim 7, wherein each video segment comprises video data between only two consecutive keyframes.

9. The system of claim 1, wherein receiving and processing the first video data by the first analytic compute endpoint comprises:
sending a request over the network to the first sensor endpoint for the first video data; and
following the processing of the first video data, storing results of the processing in a data storage instance accessible to the sensor endpoints and the analytic compute endpoints.

10. The system of claim 1, wherein the distributed compute cluster is disposed behind a firewall or router of an infrastructure network, and wherein the distributed compute cluster is made accessible from outside the firewall or router.

11. A method for distributed image processing, the method comprising:
providing a plurality of analytic compute endpoints each exposing at least one network interface, wherein the analytic compute endpoints are configured to process video data provided by a plurality of video cameras, each video camera comprising a sensor endpoint exposing at least one network interface;
identifying, by the controller, a first one of the analytic compute endpoints having available processing resources; and
facilitating, by the controller, a connection of a first one of the sensor endpoints to the first analytic compute endpoint over a network via the network interface of the first sensor endpoint and the network interface of the first analytic compute endpoint;
following the connection to the first sensor endpoint, receiving and processing the first video data by the first analytic compute endpoint.

12. The method of claim 11, wherein the analytic compute endpoints are disposed on one or more appliances having hardware separate from the plurality of video cameras.

13. The method of claim 11, wherein the analytic compute endpoints are disposed on the plurality of video cameras.

14. The method of claim 11, wherein the first analytic compute endpoint comprises a container configured to execute video data processing software using at least one processor available to the first analytic compute endpoint.

15. The method of claim 14, wherein the at least one processor comprises a central processing unit and a tensor processing unit.

16. The method of claim 11, wherein the first video data is streamed from the first sensor endpoint to the first analytic compute endpoint, the method further comprising storing the first video data as a plurality of video segments.

17. The method of claim 16, further comprising converting the video segments into pixel domain, and wherein processing the first video data comprises analyzing frames of the video segments based on one or more detection filters.

18. The method of claim 17, wherein each video segment comprises video data between only two consecutive keyframes.

19. The method of claim 11, wherein receiving and processing the first video data by the first analytic compute endpoint comprises:
sending a request over the network to the first sensor endpoint for the first video data; and
following the processing of the first video data, storing results of the processing in a data storage instance accessible to the sensor endpoints and the analytic compute endpoints.

20. The method of claim 11, wherein the distributed compute cluster is disposed behind a firewall or router of an infrastructure network, the method further comprising making the distributed compute cluster accessible from outside the firewall or router.
